(19) United States
(12) Patent Application Publication
(10) Pub. No.: US 2005/0286967 A1
(43) Pub. Date: Dec. 29, 2005

(54) Toothpaste-dispensing toothbrush

(76) Inventor: Rimas Blauzdys, Brandon (CA)

Correspondence Address: Michael R. Williams;Ade & Company, 1700-360 Main St., Winnipeg, MB, R3C 3Z3, CA

(21) Appl. No.: 11/159,251

(22) Filed: Jun. 23, 2005

Related U.S. Application Data
(60) Provisional application No. 60/582,066, filed on Jun. 24, 2004.

(51) Int. Cl. B43K 5/06; B43M 11/06

(52) U.S. Cl. 401/281; 401/185; 401/184

(57) ABSTRACT

A toothpaste dispensing toothbrush has a substantially pliable body which stores a quantity of toothpaste. Applying pressure to the body causes toothpaste to be dispensed onto the bristles of the toothbrush.

### PRIOR APPLICATION INFORMATION

This application claims benefit of U.S. Provisional Application 60/582,066, filed Jun. 24, 2004.

### BACKGROUND OF THE INVENTION

In the prior art are described a number of toothbrush designs which incorporate a toothpaste-dispensing element. However, these designs often have design features which make them impractical to operate and/or manufacture commercially. Furthermore, many of these designs are arranged to be refilled and reused which makes them too costly or undesirable for potential markets such as the hotel and hospitality industries wherein a multi-use, disposable toothbrush would be desirable.

### SUMMARY OF THE INVENTION

According to a first aspect of the invention, there is provided a toothpaste dispensing toothbrush comprising:

a deformable receptacle having a quantity of toothpaste therein; a pliable tube mounted on a rigid frame, the pliable tube being mounted within the pliable tube such that pressure on the pliable tube is applied to the deformable receptacle;

a projecting member extending from the frame and having an opening for dispensing toothpaste, said projecting member being in fluid communication with the deformable receptacle;

a toothbrush head having a base with bristles extending upwardly therefrom and a hole in the base for dispensing toothpaste from the opening onto the bristles, said toothbrush head being rotatably mounted onto the projecting member, wherein the toothbrush head rotates from an open position wherein the opening and the hole are aligned to a close position wherein the opening and the hole are out of alignment.

### BRIEF DESCRIPTION OF THE DRAWINGS

FIG. 1 is a top plan view of the toothpaste dispensing toothbrush.

FIG. 2 is a side elevational view of the toothpaste dispensing toothbrush.

FIG. 3 is a partly sectional perspective view of the toothpaste dispensing toothbrush.

FIG. 4 is a sectional view of the toothbrush head of the toothpaste dispensing toothbrush in the open position.

FIG. 5 is a sectional view of the toothbrush head of the toothpaste dispensing toothbrush in the closed position.

FIG. 6 is an exploded view of an alternative construction of the toothpaste dispensing toothbrush.

FIG. 7 is an exploded top view in partial cutaway of an alternative construction of the toothpaste dispensing toothbrush.

FIG. 8 is an exploded side view in partial cutaway of an alternative construction of the toothpaste dispensing toothbrush.

FIG. 9 is a side view in partial cutaway of an alternative construction of the toothpaste dispensing toothbrush.

FIG. 10 is a view of the base of the toothpaste dispensing toothbrush.

### DESCRIPTION OF THE PREFERRED EMBODIMENTS

Referring to the drawings, a toothpaste dispensing toothbrush 1 comprises a body 10, a hub 20 and a socket 30.

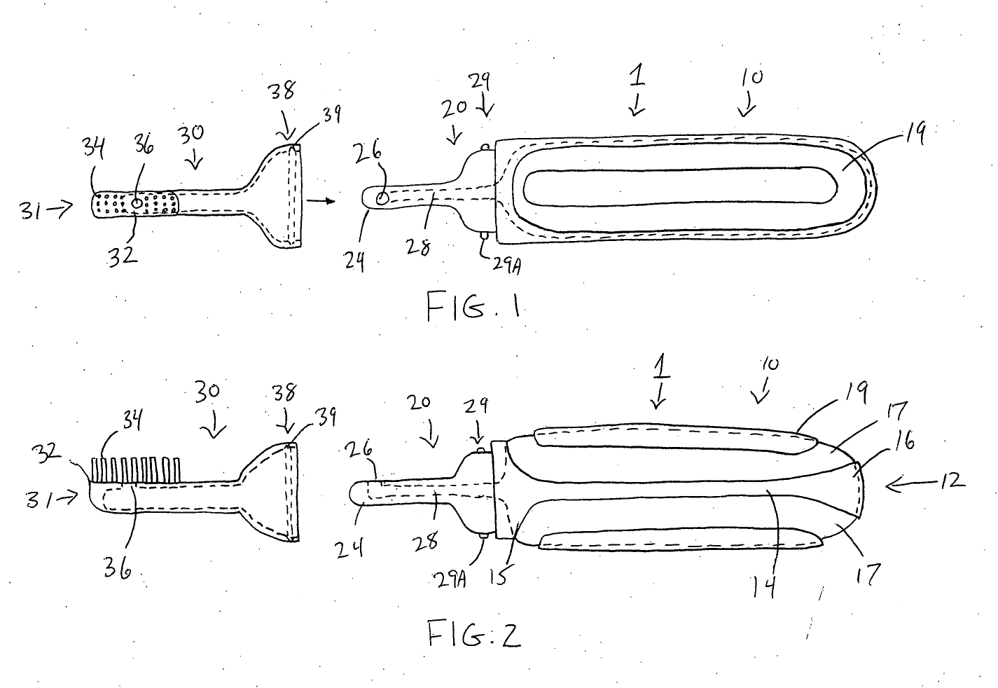

In a preferred embodiment, the body 10 is composed of a hard plastic frame 12 as shown in FIGS. 1 and 2. As can be seen, the frame 12 includes two side walls 14 joined at a top 15 and a base 16. The frame 12 is also connected to the hub 20 at the top 15 and in some embodiments may be integral with the hub 20 as discussed below. In other embodiments, the hub 20 may be arranged to be screwed onto the body 10. As will be appreciated by one of skill in the art, in these embodiments, the hub 20 may be removed for accessing the interior of the body 10. The body 10 also includes a tube 17 composed of a suitable resilient or pliable material. The tube 17 defines a cavity 18 for storing a quantity of toothpaste therein, as discussed below. Mounted onto the tube 17 are plates 19 for applying pressure to the tube 17 for ejecting toothpaste, as discussed below. It is of note that the plates 19 are not connected to the frame 12, as discussed below but rather are mounted onto the tube 17 for applying pressure to the tube 17. It is also of note that the plates 19 may be advantageously used for displaying logos or the like as a form of advertising. It is further of note that the base 16 may include an air hole 50 such that air can flow into the tube 17 after pressure on the tube 17 has been released so that the tube 17 can revert to its original shape, as discussed below and as shown in FIG. 10.

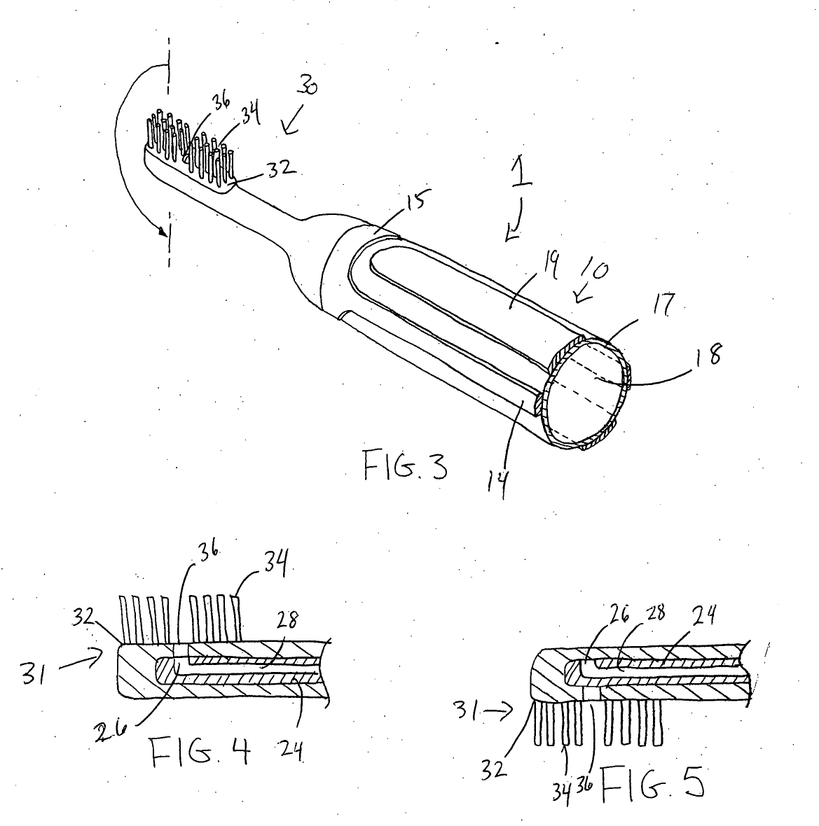

In the embodiment shown in FIG. 3, the tube 17 is inserted into the frame 12 between the top 15 and the base 16 such that the side walls 14 provide support and press against the tube 17 when pressure is applied as discussed below. In other embodiments, the tube 17 may comprise two pieces of resilient or pliable material which extend in an arc between and are connected to the side walls 14, the top 15 and the base 16 such that the two pieces are on substantially opposite sides of the body 10. Thus, in these embodiments, the components of the frame, that is, the side walls 14, the top 15 and the base 16 are connected directly to the resilient or pliable material which forms the tube 17.

The hub 20 is arranged to be inserted into the socket 30, as discussed below. The hub 20 includes a projecting element 24 which includes an opening 26. As can be seen in FIGS. 1 and 2, the projecting element 24 includes an inner channel 28 therewithin which is in fluid communication with the cavity 18 and the opening 26, as discussed below. In one embodiment, the hub 20 also includes locking members 29 which secure the socket in either the open or closed position, as discussed below. As discussed below, the projecting element 24 is arranged to be inserted directly into the socket 30.

The socket 30 comprises a toothbrush head 31 having a base 32 and a plurality of bristles 34 extending upwardly therefrom. The base 32 includes a hole 36 for ejecting toothpaste from the opening 26 onto the bristles, as discussed below. It is of note that in other embodiments, the toothbrush head 31 may include a plurality of holes. As can be seen in FIGS. 1 and 2, the socket 30 is arranged to accept the hub 20 therein such that the hole 36 and the opening 26 can be moved in and out of alignment by rotation of the socket, as discussed below. In one embodiment, the socket 30 also includes interlocking members 38 arranged to interact with the locking members 29 such that the toothpaste dispensing toothbrush 1 is held in either the open or closed position as discussed below.

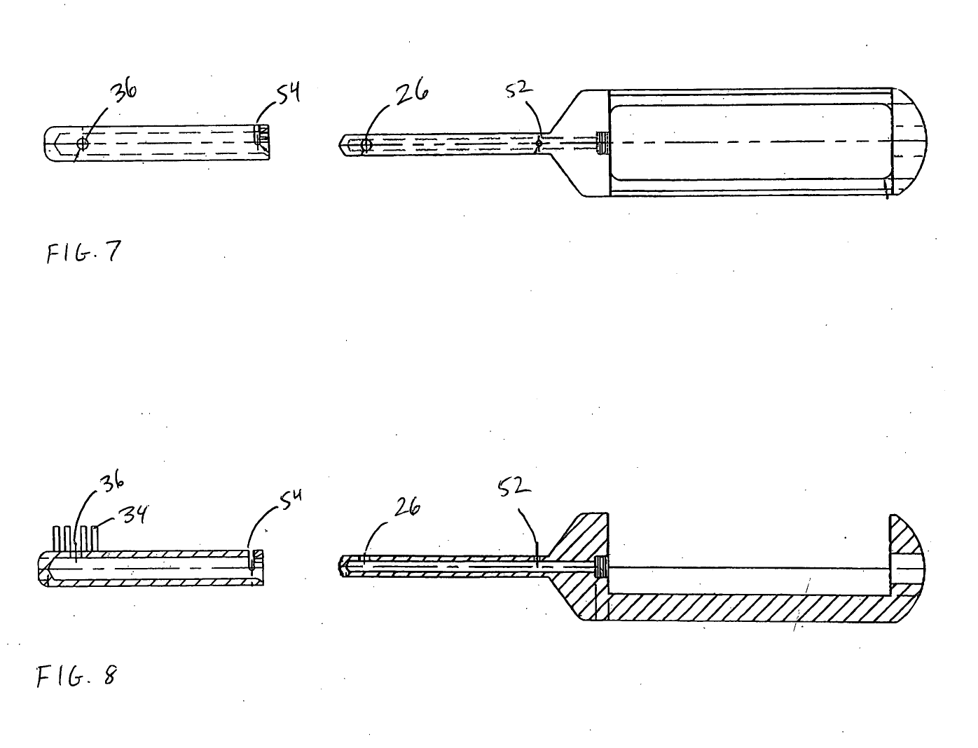

In an alternative embodiment, shown in FIGS. 7 and 8, the projecting element 24 includes a peg 52 and the socket 30 includes a slot 54. In use, the toothpaste dispensing toothbrush is assembled such that the peg 52 is inserted into the slot 54 such that the socket 30 pivots from an open position wherein the opening 26 and the hole 36 are aligned for dispensing toothpaste onto the plurality of bristles 34 to a closed position wherein the opening 26 and the hole 36 are out of alignment, as discussed below.

The tube 17 may have a substantially open top section or may have a smaller opening which is arranged to be aligned with the channel 28 during assembly.

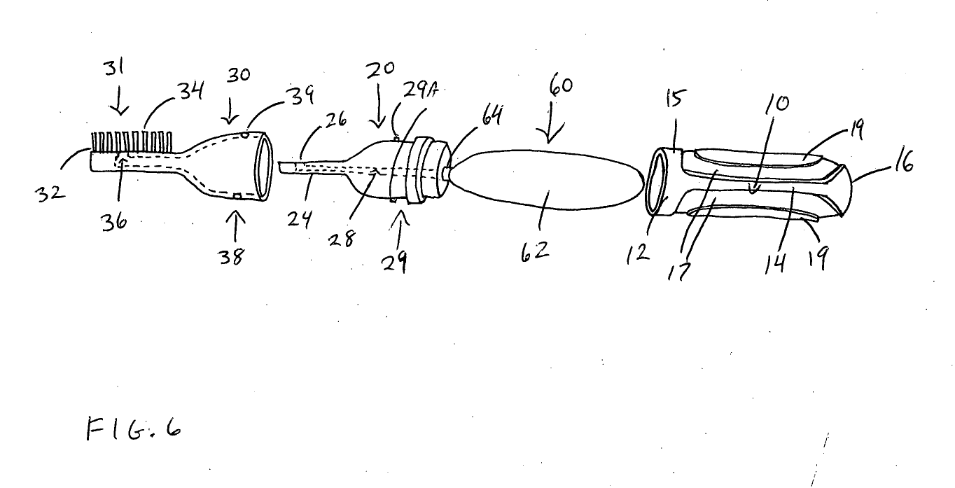

In the embodiment shown in FIGS. 1 and 2, the locking members 29 are protrusions 29A and the interlocking members 38 are slots 39 into which the protrusions 29A are inserted. As can be seen, in the embodiment shown in FIGS. 1 and 2, the protrusions 29A and the slots 39 are arranged to be diametrically opposed from one another, that is, approximately 180° offset, so that the socket 30 can be attached to the hub 20 in an open position wherein the hole 36 and the opening 26 are aligned (shown in FIG. 4) or in a closed position wherein the hole 36 and the opening 26 are out of alignment, for example, on opposite sides of the toothpaste dispensing toothbrush 1, as shown in FIG. 5. As will be appreciated by one of skill in the art, other arrangements for locking the socket 30 in place as well as other arrangements wherein the socket 30 is not moved 180° out of phase are also possible and are within the scope of the invention. For example, the socket 30 may be rotated such that the opening 26 is between 20-340° offset from the hole 36, or from 25-335°, from 30-330°, from 40-320°, from 50-310°, from 60-300°, from 70-290°, from 80-280°, from 90-270°or the like.

For use, the toothpaste dispensing toothbrush is assembled as follows. As discussed above, the frame 12 is connected to the hub 20, for example, during the molding process or following molding. The tube 17 is either fitted into or onto the side walls 14, the top 15 and the base 16 of the frame 12 as discussed above. The cavity 18 of the tube 17 also includes a quantity of toothpaste. As will be appreciated by one of skill in the art, depending on the embodiment, the toothpaste may be inserted into the cavity 18 of the tube 17 prior to or following connection to the frame 12. Similarly the plates 19 may be mounted onto the tube 17 prior to or after incorporating the tube 17 into or onto the frame 12. Preferably, two plates 19 are mounted to the tube 17 such that the plates 19 are on substantially opposite sides of the tube 17.

In an alternative embodiment shown in FIG. 6, the hub 20 and the body 10 are not integrally molded but are connected to one another during the assembly process, for example, by engaging threads or by adhesives or other suitable means known in the art.

As shown in FIG. 6, the toothpaste 60 is preferably in a deformable receptacle 62 which has a nozzle 64 that is fitted into the channel 28 of the hub 20. As a result of this arrangement and as discussed below, pressure on the tube 17 results in pressure being applied to the deformable tube 62 which in turn causes toothpaste to be ejected from the tube 62 via the nozzle 64 and into the channel 28. It is of note that unlike the resilient tube 17, the deformable receptacle 62 will not assume its original shape once pressure is removed. Thus, as used herein, “deformable” refers to the fact that the receptacle 62 does not assume its original shape once pressure is released, thereby facilitating the dispensing of toothpaste. This is in contrast with the tube 17 which is pliable, meaning that the tube 17 can be squeezed to apply pressure to the receptacle 62 but will resume its original shape once the applied pressure is discontinued.

In one embodiment, the socket 30 is then fitted onto the hub 20 such that the protrusions 29A are inserted into the respective slots 39, preferably such that the toothpaste dispensing toothbrush 1 is in the closed position, as shown in FIG. 5, wherein the hole 36 and the opening 26 are out of alignment.

In an alternative embodiment, shown in FIGS. 7 and 8, the projecting element 24 includes a peg 52 and the socket 30 includes a slot 54. In use, the toothpaste dispensing toothbrush is assembled such that the peg 52 is inserted into the slot 54 such that the socket 30 pivots from an open position wherein the opening 26 and the hole 36 are aligned for dispensing toothpaste onto the plurality of bristles 34 to a closed position wherein the opening 26 and the hole 36 are out of alignment, as discussed below.

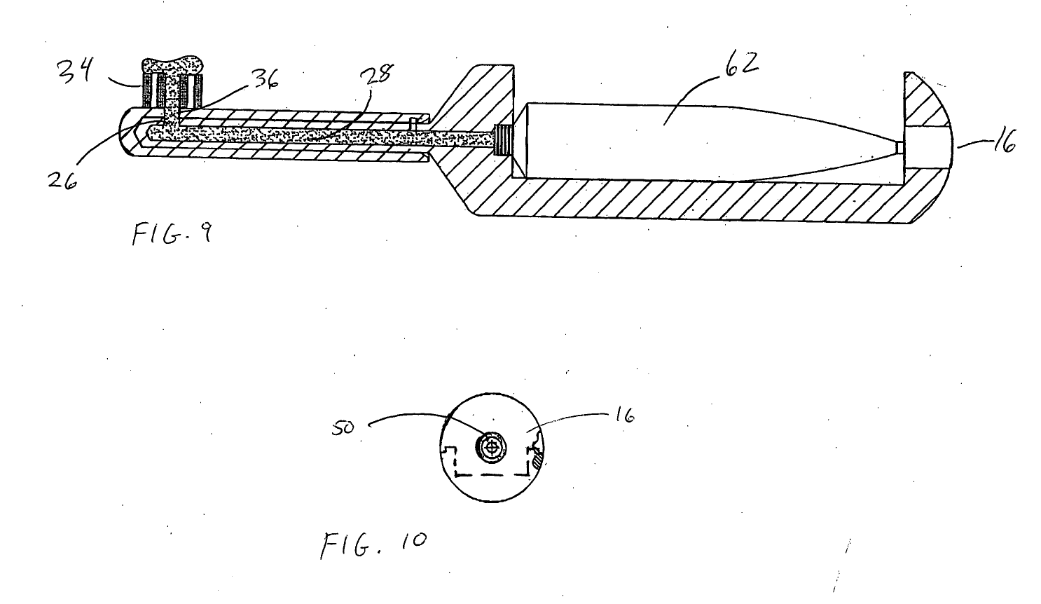

In use, the user manipulates the socket 30 and rotates the socket 30 until the hole 36 and the opening 26 are aligned, as shown in FIG. 4, such that the toothpaste dispensing toothbrush 1 is in the open position. As discussed above, in one embodiment, the user manipulates the socket 30 such that the protrusions 29A and the slots 39 disengage so that the socket 30 can be rotated so that the toothpaste dispensing toothbrush is in the open position as shown in FIG. 4. In an alternative embodiment, shown in FIGS. 7 and 8, the user manipulates the socket 30 such that the socket 30 rotates about the projecting element 24 until the opening 26 and the hole 36 are aligned. The user then applies pressure to the plates 19 which in turn causes the tube 17 to deform. The deformation of the tube 17 is resisted by the side walls 14 which in turn causes toothpaste to be forced from the cavity 18 into the channel 28 of the hub 20 such that toothpaste exits the opening 26 of the projecting element 24 and passes through the hole 36 of the toothbrush head 31 and onto the bristles 34 as shown in FIG. 9. It is of note that the tube 17 is composed of suitably resilient or pliable material such that the tube 17 can be squeezed with sufficient force to eject the toothpaste while still returning to its original shape once that pressure is removed as a result of the air hole 50. It is further of note that in some embodiments the toothpaste within the tube 17 is stored in a deformable tube 62, as discussed above.

The user then brushes their teeth as usual. Once done, the bristles 34 are rinsed and the user once again manipulates the socket 30 such that the socket 30 is turned until the hole 36 and the opening 26 are out of alignment, as shown in FIG. 5 and as discussed above.

In some embodiments, the toothpaste dispensing toothbrush 1 may further comprise a cap which is arranged to cover the bristles 34. For example, the cover may be arranged to fit directly over the bristles 34 or the toothbrush head 31 or the cover may be arranged to engage the socket 30. As will be appreciated by one of skill in the art, other suitable covering arrangements may also be used.

In some embodiments, the base 16 may be arranged to be removed from the frame 12 for accessing the cavity 18 of the tube 17 for refilling the toothpaste dispensing toothbrush 1 with toothpaste. For example, the base 16 may be arranged to snap off or to be screwed off. It is important to note however that in the preferred embodiment, the toothpaste dispensing toothbrush 1 is arranged to be non-refillable. That is, in the preferred embodiment, the toothpaste dispensing toothbrush 1 is arranged for a limited number of uses.

While the preferred embodiments of the invention have been described above, it will be recognized and understood that various modifications may be made therein, and the appended claims are intended to cover all such modifications which may fall within the spirit and scope of the invention.

1. A toothpaste dispensing toothbrush comprising:
a deformable receptacle having a quantity of toothpaste therein; a pliable tube mounted on a rigid frame, the pliable tube being mounted within the pliable tube such that pressure on the pliable tube is applied to the deformable receptacle;
a projecting member extending from the frame and having an opening for dispensing toothpaste, said projecting member being in fluid communication with the deformable receptacle;
a toothbrush head having a base with bristles extending upwardly therefrom and a hole in the base for dispensing toothpaste from the opening onto the bristles, said toothbrush head being rotatably mounted onto the projecting member, wherein the toothbrush head rotates from an open position wherein the opening and the hole are aligned to a close position wherein the opening and the hole are out of alignment.

2. The toothpaste dispensing toothbrush according to claim 1 including locking means for securing the toothpaste dispensing toothbrush in either the open position or the closed position.

3. The toothpaste dispensing toothbrush according to claim 1 including at least two plates mounted onto the pliable tube for applying pressure to the pliable tube.
